(19) United States
(12) Patent Application Publication
(10) Pub. No.: US 2012/0193353 A1
(43) Pub. Date: Aug. 2, 2012

(54) Closure Having Identical Halves

(75) Inventors: Edward P. Cronin, Brodhead, WI (US); George Solowiejko, Rockford, IL (US); Charles R. Jones, JR., Rockford, IL (US); Phil Baerenwald, Machesney Park, IL (US)

(73) Assignee: J.L. CLARK, INC., Rockford, IL (US)

(21) Appl. No.: 13/354,194

(22) Filed: Jan. 19, 2012

Related U.S. Application Data
(60) Provisional application No. 61/438,153, filed on Jan. 31, 2011.

(51) Int. Cl. B65D 6/00; B23P 11/00; B65D 55/02

(52) U.S. Cl. 220/4.22; 29/434

(57) ABSTRACT

A closure formed from a pair of closure halves and methods of forming are provided. In one embodiment a closure having identical closure halves is provided. The first closure half includes a first male hinge portion and a first female hinge portion. The second closure half includes a second male hinge portion and a second female hinge portion. The second male hinge portion interfits with the first female hinge portion and cooperate to form a first hinge arrangement defining a first hinge axis. The second female hinge portion interfits with the first male hinge portion and cooperate to form a second hinge arrangement defining a second hinge axis. The first and second hinge axis are co-axial and the first and second closure halves rotate relative to one another via the first and second hinge arrangements about the first and second hinge axes between open and closed states.

### CROSS-REFERENCE TO RELATED PATENT APPLICATIONS

This patent application claims the benefit of U.S. Provisional Patent Application No. 61/438,153, filed Jan. 31, 2011, the entire teachings and disclosure of which are incorporated herein by reference thereto.

### FIELD OF THE INVENTION

This invention generally relates to closures and particularly to portable closures for storing or protecting objects such as portable electric tools and portable medical devices.

### BACKGROUND OF THE INVENTION

Portable objects such as electric power tools or medical devices that are often carried from one location to another are often carried and stored in plastic closures. The closures can be used to protect the device in the event that it is dropped. The closures also provide an easy way to store the object if it is oddly shaped such as a drill, saw, etc. The closure can be formed into a shape such as a cube or prism that can easily sit on a floor, shelf or other smooth surface. The closure can also be used to store additional attachments, cords, or operator manuals for the device.

These closures will typically have two closure halves that are hingedly coupled to one another for pivoting between open and closed states.

Unfortunately, due to the various different sizes and shapes of the enclosures for different objects, it can be necessary to form many different molds to form the numerous different necessary closures. Unfortunately, because these containers have two separate halves, multiple molds are typically need for a single enclosure design (one for each half). Unfortunately, this can be cost prohibitive for small run designs.

The present invention relates to improvements over the art with regard to closures and particularly portable closures.

### BRIEF SUMMARY OF THE INVENTION

The present invention relates to improvements in the art for closures having shells that are hingedly coupled to one another.

In one embodiment a closure having identical closure halves is provided.

In a more particular embodiment, a closure including first and second closure halves is provided. The first closure half includes a first male hinge portion and a first female hinge portion. The second closure half includes a second male hinge portion and a second female hinge portion. The second male hinge portion is configured to interfit with the first female hinge portion and cooperate to form a first hinge arrangement defining a first hinge axis. The second female hinge portion is configured to interfit with the first male hinge portion and cooperate to form a second hinge arrangement defining a second hinge axis. The first and second closure halves are identical. The first and second hinge axis are co-axial and the first and second closure halves rotate relative to one another via the first and second hinge arrangements about the first and second hinge axes between open and closed states.

In one embodiment, each of the first and second closure halves include a peripheral sidewall bounding an internal cavity. The peripheral sidewall has an open distal end. The open distal end defines a continuous periphery. The open distal end of the peripheral sidewall includes a first interfitting wall portion extending substantially no more than one half the length of the periphery and a second interfitting wall portion extending substantially no more than one half the length of the periphery.

In one embodiment, substantially no length of the first interfitting wall portion overlaps any substantial length of the second interfitting wall portion at any point along the length of continuous periphery.

In one embodiment, the first interfitting wall portion of the first closure half is positioned radially outward from and overlaps with a length of the second interfitting wall portion of the second closure half when the first and second closure halves are in the closed state.

In one embodiment, the first interfitting wall portion of the first closure half is spaced laterally outward from the second interfitting wall portion of the first closure half

In one embodiment, the distal end of the peripheral sidewall includes a third interfitting wall portion extending no more than one half the length of the periphery of the peripheral sidewall. The third interfitting wall portion is spaced laterally outward from the second interfitting wall portion defining a receiving channel therebetween.

In one embodiment, when in the closed state, the first interfitting wall portion of the first closure half is positioned within the receiving channel of the second closure half and the first interfitting wall portion of the second closure half is positioned within the receiving channel of the first closure half.

In one embodiment, the closure further includes first and second hinge pins. The first hinge pin passes through the first female hinge portion and second male hinge portion along the first hinge axes to couple the first female hinge portion to the second male hinge portion. The second hinge pin passes through the first male hinge portion and second female hinge portion along the second hinge axes to couple the first male hinge portion to the second female hinge portion.

In one embodiment, the first male hinge portion includes a first tab including a hinge pin receiving channel and the second female hinge defines a first pair of spaced apart tabs defining hinge pin receiving channels. The second male hinge portion defines a second tab including a hinge pin receiving channel and the second female hinge defines a second pair of spaced apart tabs defining hinge pin receiving channels. The first tab is interposed between the tabs of the second pair of spaced apart tabs and the second tab is interposed between the tabs of the first pair of spaced apart tabs. All hinge pin receiving channels are substantially co-axial.

In a more particular embodiment, the closure further includes first and second hinge pins. The first hinge pin passes through the first tab and second pair of spaced apart tabs. The second hinge pin passing through the second tab and the first pair of spaced apart tabs.

In one embodiment, the first closure half includes a first peripheral sidewall and the second closure half includes a second peripheral sidewall. The first male hinge portion includes a first clip arrangement hingedly attached to the first peripheral sidewall. The second male hinge portion includes a second clip arrangement hingedly attached to the second peripheral sidewall. The first female hinge portion includes a catch channel matingly receiving the first clip arrangement therein. The second female hinge portion includes a catch channel matingly receiving the second clip arrangement therein.

In one embodiment, the first clip arrangement includes a pair of first prongs separated by a first biasing channel. The pair of first prongs extending into the catch channel of the second female hinge portion. At least one of the pair of first prongs includes a catch for engaging a cooperating catch structure of the second female hinge portion to secure the first clip arrangement within the catch channel.

In one embodiment, the first clip arrangement further includes a locking member having a locked state wherein the locking member extends between the pair of first prongs preventing the pair of first prongs from resilient biasing towards one another such that the catch cannot disengage the cooperating catch structure.

In one embodiment, the locking member includes an unlocked state wherein the locking member does not extend between the pair of first prongs such that the pair of first prongs can be resiliently biased towards one another such that the catch can disengage the cooperating catch structure. However, in the unlocked state, the locking member may be positioned between the pair of prongs.

A method of forming a closure is also provided. The method includes providing a pair of identical closure halves, each half having a male hinge portion and a female hinge portion; coupling the pair of identical closure halves such that the male hinge portion of each closure half interfits with the female hinge portion of the other one of the closure halves.

In one embodiment, the method further includes comprising inserting a hinge pin through each set of interfitted male and female hinge portions. The pair of closure halves being pivotable about the hinge pins. The hinge pins being aligned co-axial.

In one embodiment, each closure half includes a main body that defines a storage cavity. The male hinge portion is hingedly coupled to the main body. The male hinge portion includes a first catch portion and the female hinge portion includes a cooperating second catch portion. The step of coupling includes engaging the first and second catch portions such that the male and female hinge portions are fixed to one another.

In one embodiment, the method further includes the step of locking the position of the first catch portion to prevent disengagement of the first catch portion from the second catch portion.

In one embodiment, the male hinge portion includes a catch prong that includes the first catch portion. The step of locking the position of the first catch portion includes abutting a prop against the catch prong to prevent biasing of the catch prong away from the second catch portion. In one more particular embodiment, the prop is formed as part of the male hinge portion. In one embodiment, the step of abutting a prop includes rotating the prop from a disengaged state that permits resilient biasing of the catch prong away from the second catch portion into a locked state that prevents resilient biasing of the catch prong away from the second catch portion.

In one embodiment, both closure halves are formed using the same mold, at separate times. More particularly, the first closure half is formed using a mold. Then after the first closure half is formed using the mold, the second closure half is formed using the same mold as the first closure half.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top perspective illustration of a container according to a first embodiment of the invention;

FIG. 2 is a rear perspective illustration of the container of FIG. 1;

FIG. 3 is a perspective illustration of the container of FIG. 1 in an open state;

FIG. 4 is a partial illustration of a rear portion of a container half of the container of FIG. 1;

FIG. 5 is an enlarged portion of the male hinge portion of one of the container halves;

FIG. 6 is a partial illustration of one of the container halves showing the female hinge portion and a male hinge portion in mating engagement;

FIG. 7 is a top perspective illustration of a single one of the container halves of FIG. 1;

FIG. 8 is an enlarged perspective illustration of a buckle latch of the container of FIG. 1;

FIG. 9 is a partial illustration of a container half illustrating the catches that cooperate with the buckle latch;

FIG. 10 is a cross-sectional illustration of the container of FIG. 1;

FIG. 11 is a front top perspective illustration of a further embodiment of a container according to the invention;

FIG. 12 is a rear top perspective illustration of the container of FIG. 11;

FIG. 13 is a top perspective illustration of the container of FIGS. 11 and 12 shown in an open state;

FIG. 14 is a partial rear illustration of the container of FIG. 11 showing the hinge arrangements thereof;

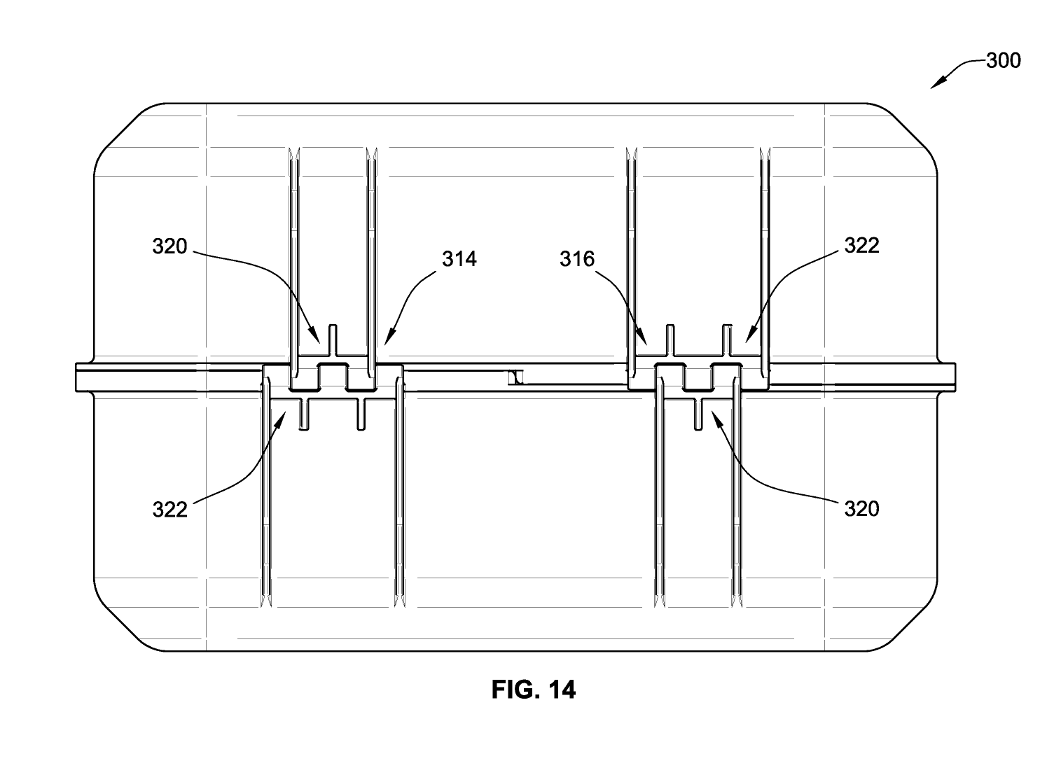

FIG. 15 is a top illustration of a container half according to the embodiment of FIG. 11 illustrating the hinge pins thereof;

FIG. 16 is a partial top perspective illustration of the male and female hinge portions of the container of FIG. 11; and

FIG. 17 is an enlarged illustration of the male hinge portion of FIG. 4.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

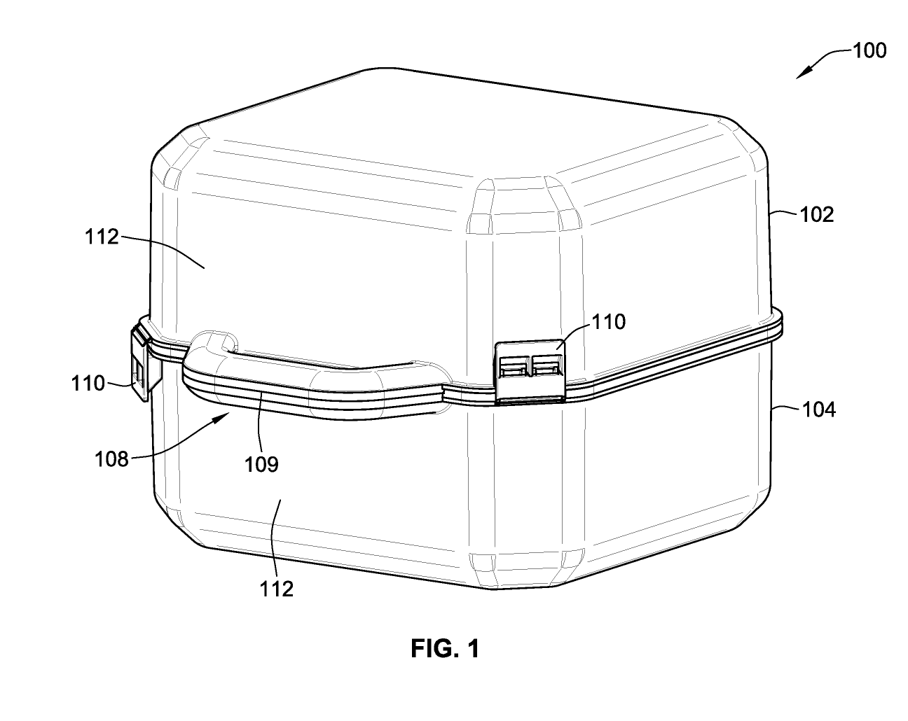

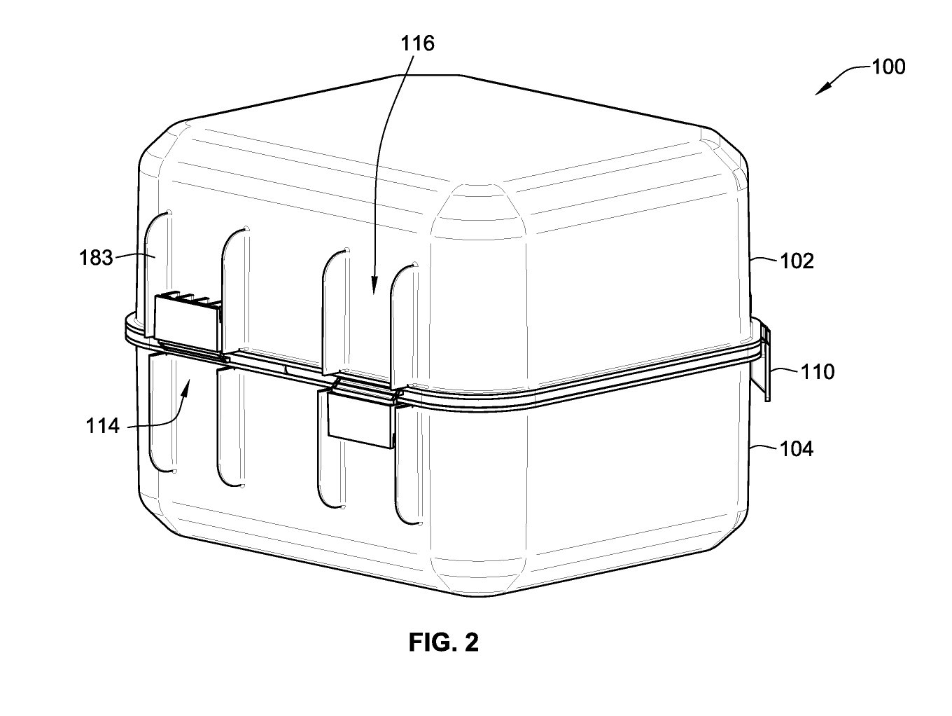

FIG. 1 and FIG. 2 illustrate a closure 100 according to an exemplary embodiment of the present invention. The closure 100 is preferably formed from a pair of closure halves 102, 104. The closure halves 102, 104 are preferably identical to one another. In fact, in a preferred implementation of the invention, the closure halves 102, 104 are formed using a single mold. This identicality between the two closure halves 102, 104 provides for significant reduction in production costs due to the use or ability to use one mold for both halves of the closure 100. This is particularly true for short run closures where it would be otherwise impractical to create two molds, one for each side of the closure.

With reference to FIG. 1, the closure 100 generally includes a handle 108. One portion of the handle 108 is provided by the first closure half 102 and a second portion of the handle 108 is provided by the second closure half 104. In the illustrated embodiment, the handle 108 is separated at parting line 109. However, the handle could be separated in parting line that runs vertically.

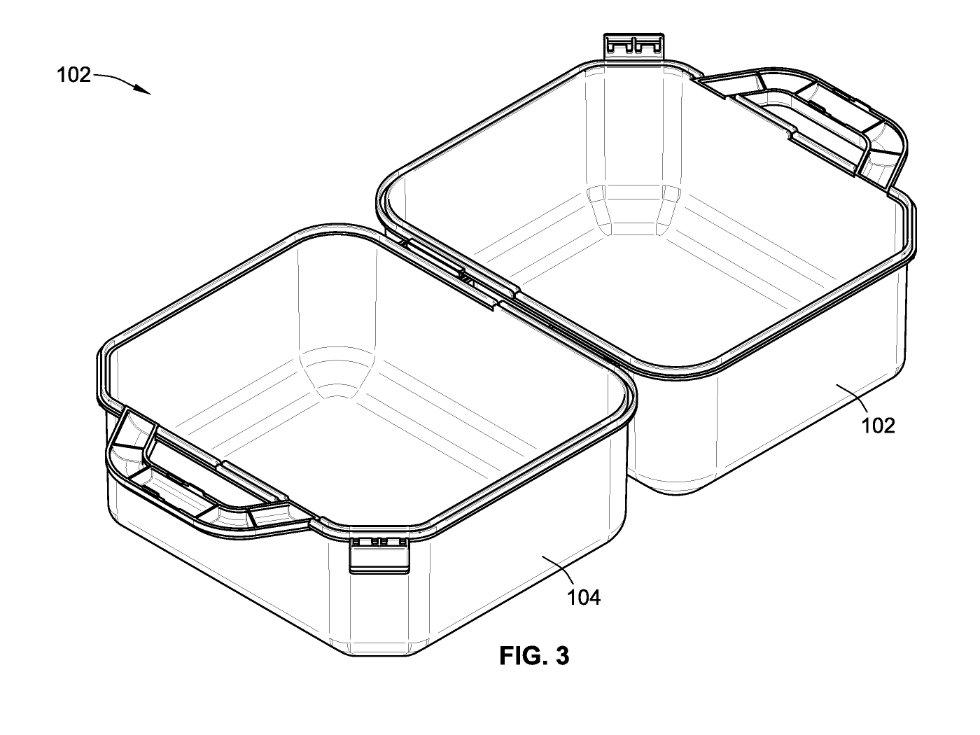

As will be more fully disclosed below, the closure halves 102, 104 are hingedly coupled to one another such that the two halves 102, 104 can rotate relative to one another between a closed state (as illustrated in FIGS. 1 and 2) and an open state (as illustrated in FIG. 3). In the open state, the internal compartment formed by the closure halves 102, 104 can be accessed to insert or remove product carried therein.

To maintain the closure 100 in the closed state, the closure halves 102, 104 each include a buckle latch 110. The buckle latch 110 is hingedly coupled to a body portion 112 of the closure halves 102, 104. In one embodiment, the hinged relationship is provided by a living hinge formed between the buckle latch 110 and the body portion 112. As such, in the illustrated embodiment, the buckle latch 110 and closure body 112 are formed as a continuous piece of material formed during a single molding operation.

With reference to FIG. 2, the closure 100 includes a pair of hinge arrangements 114, 116. The hinge arrangements 114, 116 allow the two closure halves 102, 104 to rotate relative to one another between the open (FIG. 3) and closed (FIGS. 1 and 2) states. The hinge arrangements 114, 116 are also used to couple the closure halves 102, 104 to one another.

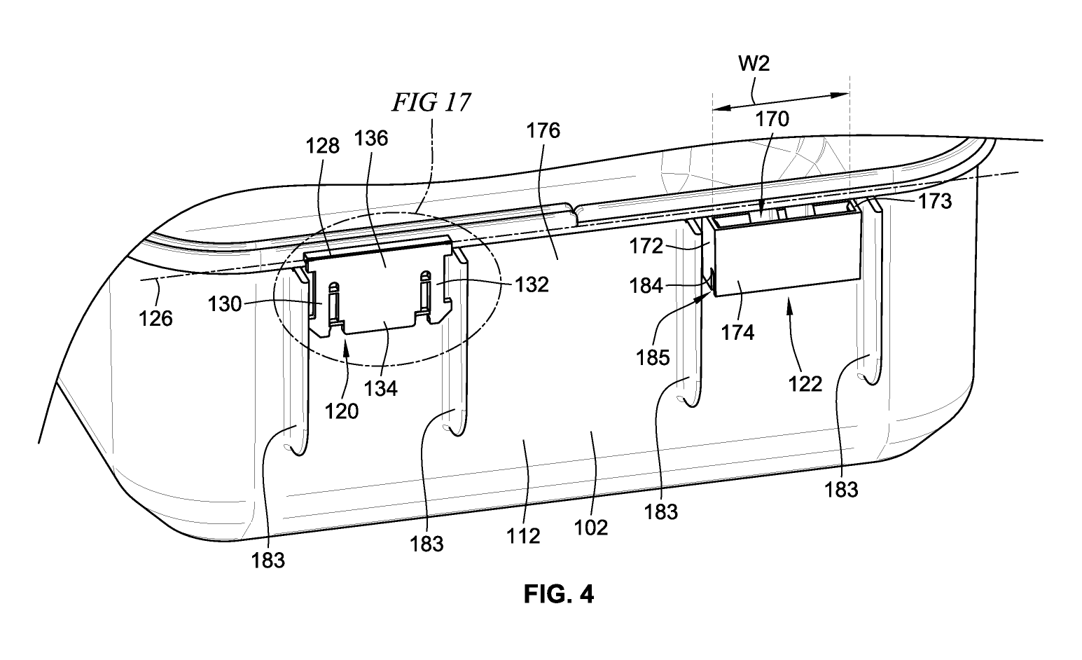

With reference to FIG. 4, substantially only the first closure half 102 is illustrated. In this illustration, the components of a hinge arrangement are illustrated. Because each closure half 102, 104 provides exactly half of the closure, each hinge arrangement 114, 116 includes a portion formed by the first closure half 102 and a second portion formed by the second closure half 104. More particularly each closure half 102, 104 will include a male hinge portion and a female hinge portion.

As the two closure halves 102, 104 are identical in the exemplary embodiment, only a single one of the closure halves will be discussed and explained. However, where the interaction between the two closure halves 102, 104 is necessary it will be referenced as such.

As shown in FIG. 4, closure half 102 includes a male hinge portion 120 and a female hinge portion 122. The male hinge portion 120 will cooperate with a female hinge portion of the second closure half 104 while the female hinge portion 122 of closure half 102 will interact and cooperate with a male hinge portion of the second closure half 104.

With reference to FIGS. 4, 5 and 17, the male hinge portion 120, in the illustrated embodiment, is hingedly coupled to body portion 112 for rotation about hinge axis 126 defined by living hinge 128 that hingedly connects the male hinge portion 120 to body 112.

The male hinge portion 120 is in the form of a clip arrangement and includes a pair of outer prongs 130, 132 that are laterally spaced apart from one another. Interposed between prongs 130, 132 is an intermediate prong 134. The three prongs 130, 132, 134 are formed as a continuous piece of material and are connected to one another generally at their base portions. More particularly, the base portions of prongs 130, 132, 134 are interconnected by a connection portion 136.

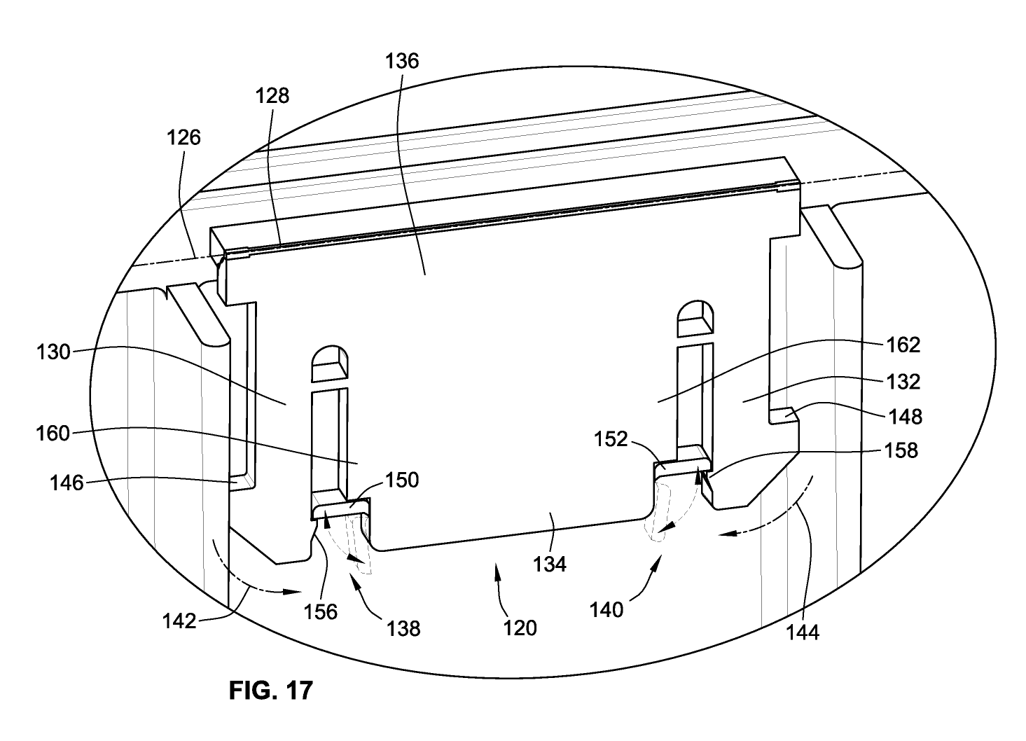

First prong 130 is laterally spaced from intermediate prong 134 such that a biasing channel 138 is formed therebetween. Similarly, second prong 132 is laterally spaced from the intermediate prong 134 such that a second biasing channel 140 is formed therebetween. The biasing channels 138, 140 provide a relief zone that allows the first and second prongs 130, 132 to be resiliently biased towards the intermediate prong 134 as illustrated by arrows 142, 144 (see FIG. 17). Prongs 130, 132 will be biased towards intermediate prong 134 when they are matingly received into a corresponding female hinge portion of a cooperating closure half such as closure half 104. Once the male hinge portion 120 is fully inserted into the cooperating female hinge portion, the prongs 130, 132 will be able to bias back outward and away from intermediate prong 134 to engage cooperating structure of the female hinge portion.

The first and second prongs 130, 132 include catches for engaging with cooperating structure of the female hinge portion. These catches are illustrated in this embodiment as laterally outward extending abutment walls 146, 148. These abutment walls 146, 148 will be used to engage corresponding abutment walls or catch portions of the female hinge portion of the second closure half 104.

The distal ends of the first and second prongs 130, 132 may be tapered to include a cam surface to further facilitate insertion of the male hinge portion 120 into a catch channel of the cooperating female hinge portion, and particularly flexure thereof.

The male hinge portion 120 further includes a pair of lock members 150, 152. The lock members 150, 152 are used to reinforce or otherwise support the first and second prongs 130, 132 once the male hinge portion 120 is inserted into the cooperating female hinge portion. The lock members 150, 152 are interposed between the intermediate prong 134 and the corresponding first or second prong 130, 132.

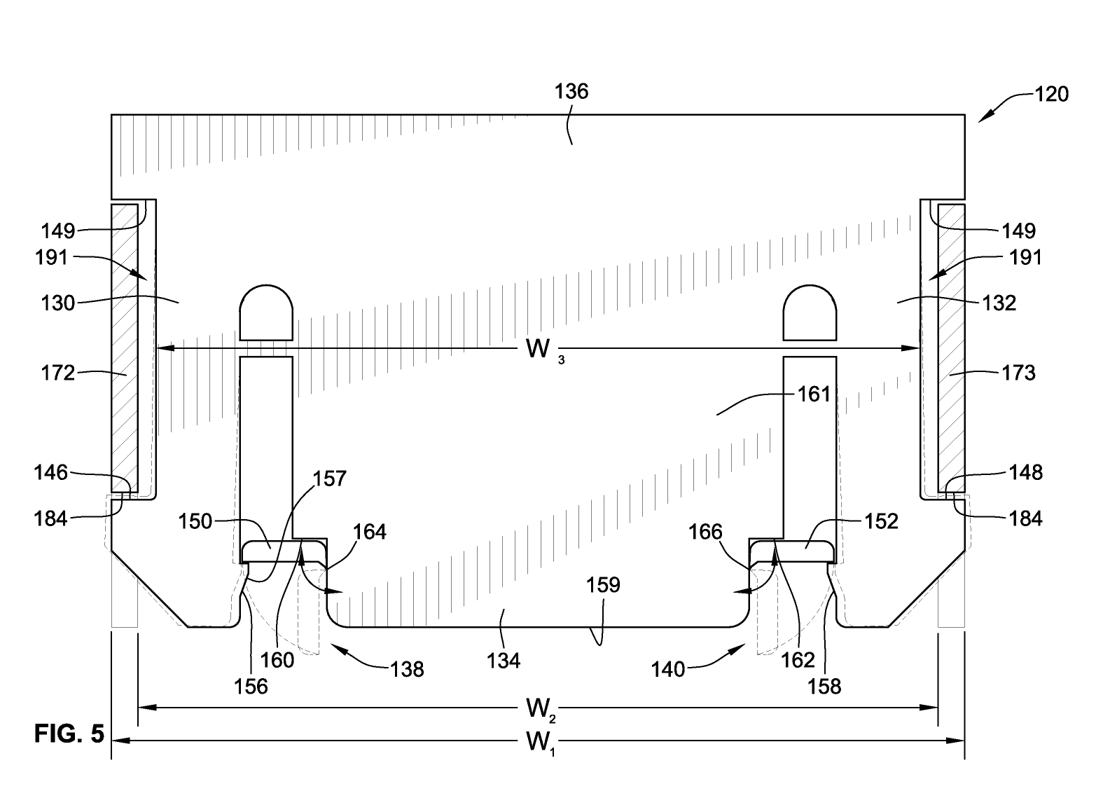

These lock members 150, 152 rotate between locked and unlocked states. In the locked state (as illustrated in FIGS. 4 and 5), the lock members 150, 152 provide a prop to prevent resilient biasing of the first and second prongs 130, 132 towards intermediate prong 134. More particularly, the lock members 150, 152 prevent or resist the distal ends of prongs 130, 132 from being biased laterally towards the intermediate prong 134 thereby inhibiting removal of the male hinge portion 120 from being removed from a female hinge portion. These lock members 150, 152 substantially traverse the channels 138, 140. The inclusion of lock members 150, 152 adjusts the bending characteristics of prongs 130, 132.

With reference to FIG. 5, the lock members 150, 152 are preferably formed as a continuous portion of intermediate prong 134. A living hinge 164, 166 is preferably formed between the lock members 150, 152 and the intermediate prong 134. The living hinge allows the lock members 150, 152 to rotate between the locked and unlocked states.

To maintain the lock members 150, 152 in the locked state, prong 130 includes a lock catch 156 that engages the distal end of lock member 150 when lock member 150 has been rotated into the locked position. The lock catch 156 prevents the lock member 150 from rotating back towards the unlocked state. More particularly, it prevents the lock member 150 from rotating counterclockwise as illustrated in FIG. 5. The lock catch includes a tapered surface 157 that assists in transitioning the lock member 150 to the locked position. The same arrangement is provided for in second prong 132 and it includes lock catch 158. The lock catches 156, 158 provide an undercut or abutment that engages the distal end of the lock members 150, 152.

The male hinge portion 120 in the illustrated embodiment can also be referred to as a buckle clip. The male hinge portion 120 in FIG. 4 is preferably formed as a continuous piece of material with the rest of the closure half 102. As such, the lock member 150, 152 are preferably formed as a continuous piece with the rest of the male hinge portion 120, and particularly intermediate prong 134. In some implementations, the lock members 150, 152 can be formed after the molding process of the closure half 102. More particularly, a wedge or other tool can be used to cut a portion of the sides of the intermediate prong 134 to form the lock members 150, 152.

Preferably, the lock members 150, 152 are recessed laterally inward from the rest of the sides of the intermediate prong 134. This provides a stepped profile for the intermediate prong 134 such that the distal end 159 of the intermediate prong 134 has a reduced width. The stepped profile allows the wider portion 161 of intermediate prong 134 that extends laterally outward relative to the distal end of the intermediate prong 134 to act as a stop that prevents over rotation of the lock members 150, 152 when transferring the lock members into the locked configuration. More particularly, the stepped profile provides abutment portions 160, 162. These abutment portions 160, 162 provide positive stops inhibiting over-rotation of the lock members 150, 152

The lock members 150, 152 are coupled to intermediate prong 138 by living hinges 164, 166.

While the lock members are illustrated as part of intermediate prong 134, the lock members could be hingedly coupled to the outer prongs 130, 132. Further, the intermediate prong need not be provided in some embodiments. Instead, a single gap could be formed between the outer prongs 130, 132 and a single lock member could extend between the two prongs. Further yet, other embodiments do not need to include abutment walls 146, 148 on both prongs 130, 132.

The connection portion 136 has a width that is stepped as well and includes abutment portions 149. These abutment portions 149 are used to prevent over insertion of the male hinge portion 120 into a cooperating female hinge portion, which could inhibit pivoting of the two halves 102, 104 relative to one another. These abutment portions 149 can abut a corresponding structure of the female hinge portions of the other closure half

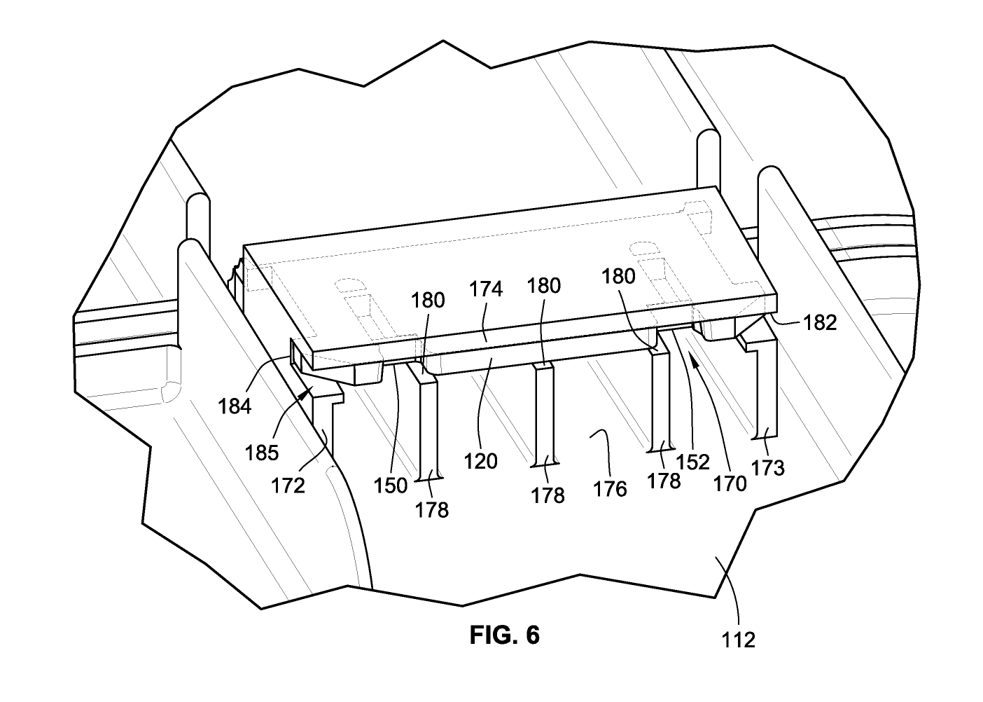

With reference to FIGS. 4 and 6, the female hinge portion 122 generally provides a catch channel 170 that receives a corresponding male hinge portion 120 from the other closure half 104. The catch channel 170 is bounded by a plurality of wall portions that are integrally formed as a continuous piece of material with the main body portion 112 of the closure half 102. The female hinge portion 122 includes a pair of outward extending sidewalls 172, 173. The outward extending sidewalls 172, 173 extend outward in a cantilevered relation.

An outer wall 174 is attached to outer ends of the outward extending walls 172, 173. The outward extending sidewalls 172, 173 thus offset the outer wall 174 from a peripheral sidewall 176 of main body portion 112. The catch channel 170 is generally formed between the outer wall 174 and a plurality of stand-offs 178 (see FIG. 6). These stand-offs 178 extend laterally outward from main body portion 112. The spacing between the distal ends 180 of stand-offs 178 and the inner surface 182 is sized to receive the male hinge portion 120.

Outward extending sidewalls 172, 173 define cooperating catch structures. Catch structure 184 is shown in FIG. 6. This catch structure 184 is an abutment surface that axially abuts against the corresponding abutment wall of one of the male hinge portions 120. The catch structure 184 is formed as the bottom of the channel 185 formed in the sidewall portions 172, 173 of the female hinge portion 122.

In a preferred embodiment, the distal ends of the prongs 130, 132, 134 are recessed and fully hidden behind the outer wall 174. This arrangement protects the prongs 130, 132 from being tampered with or undesirably disengaged from the female hinge portion 122.

Further, the width W3 (see FIG. 5) extending between outer surfaces of the prongs 130, 132 is substantially equal to and slightly smaller than the width W2 of the catch channel 170. The abutments 149 and catch walls 146, 148 face one another and form undercut regions 191 therebetween.

During assembly of the closure 100, the male hinge portions of the closure halves 102, 104 are inserted into the corresponding female hinge portions 122 of the other one of the closure halves 102, 104. At this time, the lock members 150, 152 are in an unlocked state and the distal ends thereof are not engaging the corresponding prongs 130, 132. In this state, prongs 130, 132 of the male hinge portions 120 are permitted to flex laterally inward towards the corresponding intermediate prong 134. This allows the prongs 130, 132 to insert into the catch channel 170.

Once the male hinge portions 120 are sufficiently inserted into the female hinge portions 122 (typically when abutments 149 are resting on a top surface of sidewalls 172, 173), the abutment walls 146, 148 will have passed beyond the corresponding catch structure 184 of the female hinge portions 122. At this point, the prongs 130, 132 will again resiliently flex laterally outward. At this time, the abutment walls 146, 148 will axially engage or be adjacent to the corresponding cooperating catch structures 184 of the female hinge portions 122. This axial abutment will secure the two closure halves 102, 104 together.

Once fully installed, abutment portions 149 will rest on the top surface of the sidewalls 172, 173 of female hinge portion 122. The segment of sidewalls 172, 173 formed between the top surface and the catch structure 184 will be positioned within undercut regions 191 of the male hinge portion 120.

After the male hinge portions 120 have been inserted into the female hinge portions 122, the lock members 150, 152 will be rotated such that their distal ends will engage the outer prongs 130, 132. Further, they will be rotated past the lock catches 156, 158 to prevent rotation back towards the unlocked state. In this configuration, the male hinge portions 120 are substantially unremovable from the female hinge portions 122.

In a relaxed state, the width W1 of the male hinge portion 120 measured from the laterally outer edges of the abutment walls 146, 148 is greater than the width W2 of the catch channel 170 defined between the inner surfaces of sidewalls 172, 173.

Once assembled, the combination of the male and female hinge portions 120, 122 define the hinge arrangements 114, 116 (see FIG. 2).

With reference to FIG. 2, the closure halves 102, 104 also include feet 183 that protect the hinge arrangements 114, 116 and provide a smooth structure for resting the closure on a flat surface, such as a table, shelf or the ground. The feet 183 protect the hinge arrangements 114, 116 such that if the closure 100 is dropped, the hinge portions 120, 122 of the hinge arrangements 114, 116 do not disengage.

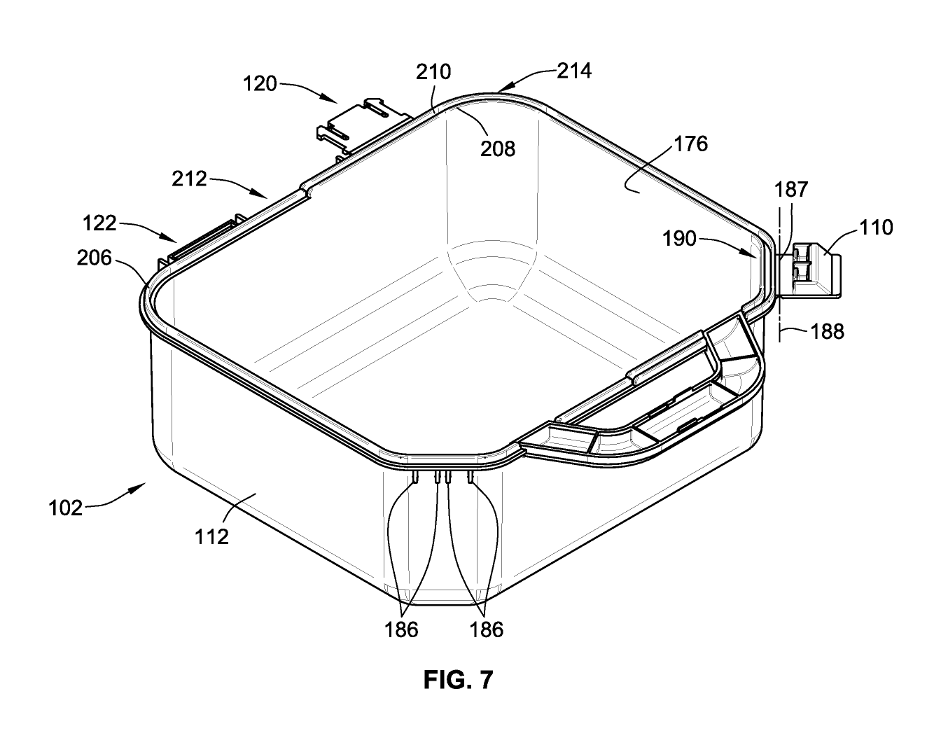

FIG. 7 illustrates the container half 102 in an as molded state. In FIG. 7, the male hinge portion 120 extends generally horizontal. However, in other embodiments, the male hinge portion 120 could extend vertically upward (i.e. rotated 90 degrees from the illustrated position).

With reference to FIG. 7, each closure half includes a buckle latch 110. The buckle latch 110 cooperates with catches 186 of the other closure half to secure the closure halves 102, 104 in a locked condition. The buckle latches 110 are hingedly coupled to the main body portion 112 by living hinges 187 for rotation about latch axis 188. The latches 110 are formed and attached at corner portions 190 of peripheral sidewall 176.

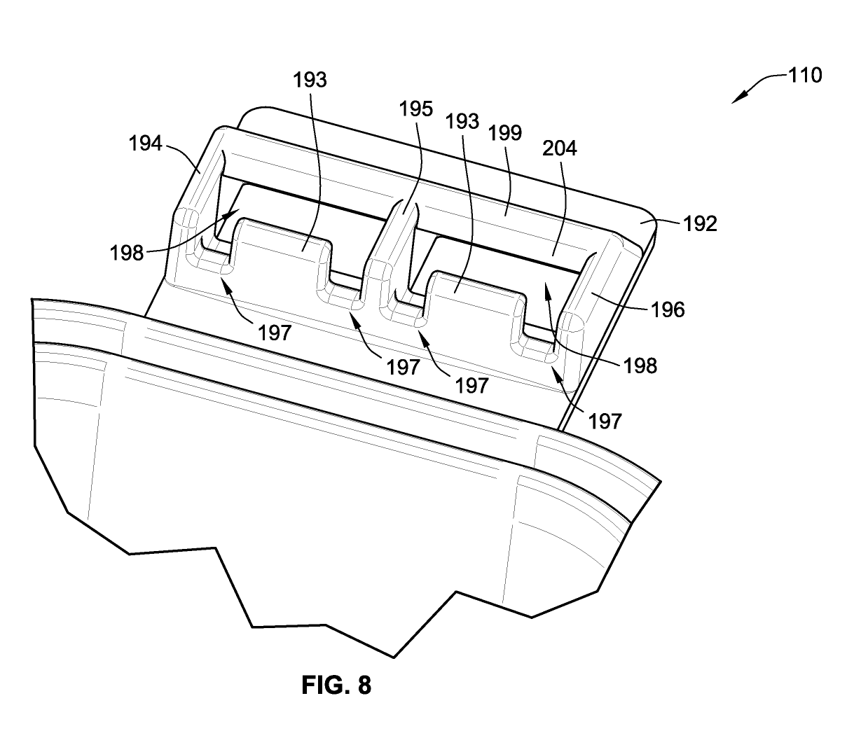

FIG. 8 illustrates the buckle latch 110 in enlarged form. The buckle latch 110 includes a main body portion 192. One end of the main body portion 192 is coupled via the living hinge 187 to main body portion 112. The other end is used by the user as a grip for disengaging the buckle latch 110 from catches 186.

Extending outward from the main body portion 192 are a pair of separation tabs 193. The buckle latch 110 further includes three guide walls 194-196. The guide walls 194-196 and tabs 193 define receiving channel 197 through which catches 186 extend when the buckle latch 110 is in a locked state.

The buckle latch 110 also includes a pair of catch cavities 198 that are formed between a catch overhang wall 199 and main body portion 192. More particularly, catch overhang wall 199 is spaced from main body portion 192.

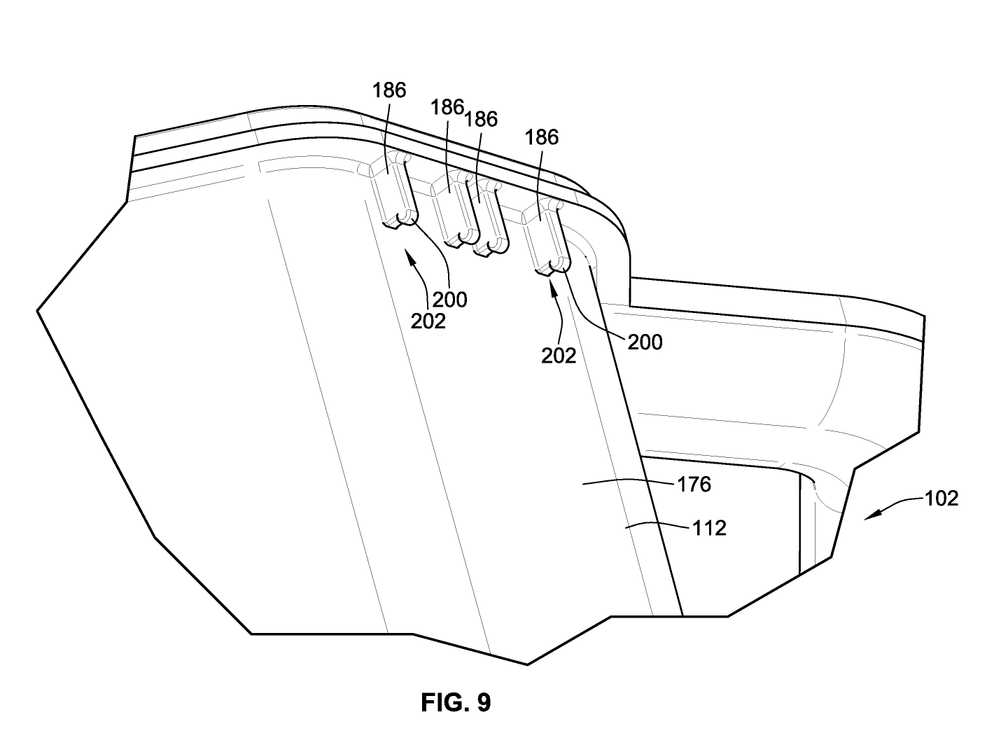

The catches (see FIG. 9) include nibs 200 that extend into the catch cavities 198 and engage catch overhang wall 199 to secure the closure halves 102, 104 in a locked state. The nibs 200 are spaced outward from the outer surface of the peripheral sidewall 176 of the main body portion 112 forming an undercut region 202 therebetween. The free edge 204 of the catch overhang wall 199 extends into the undercut region 202 when the buckle latch 110 is in a locked state.

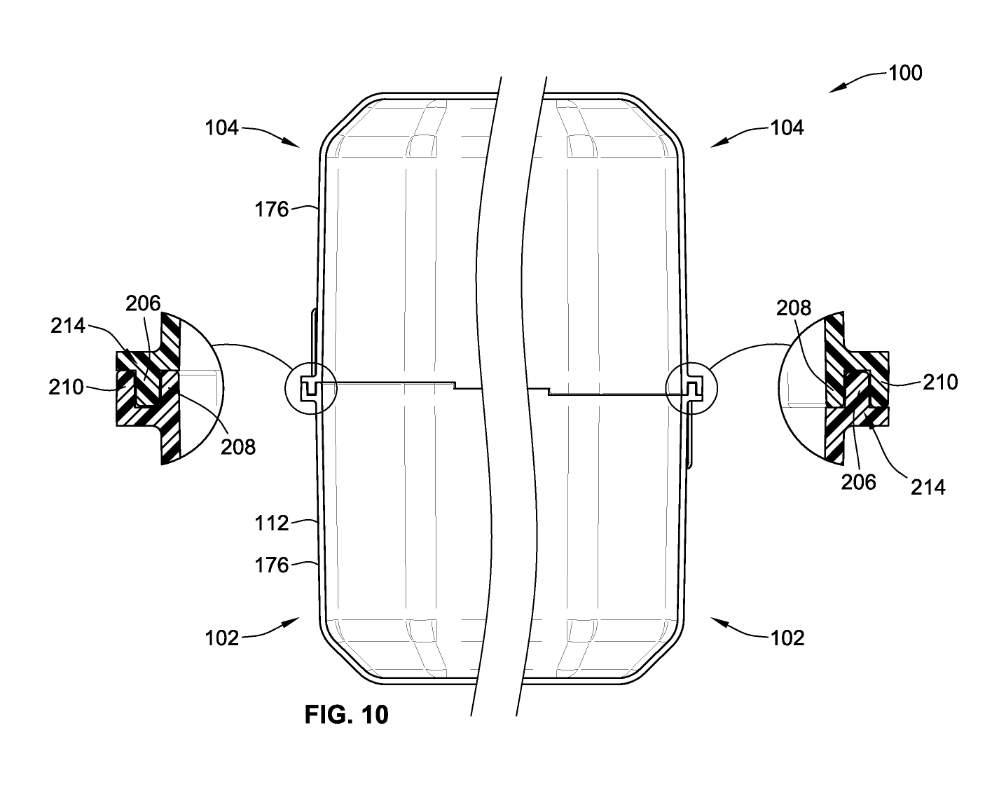

With reference to FIGS. 7 and 10, the closure halves 102, 104 include three inter-fitting wall portions 206, 208, 210. Formed at or into the distal end 212 of peripheral sidewall 176. The first inter-fitting wall portion 206 is received into a receiving channel 214 formed between the second and third inter-fitting wall portions 208, 210 of the other closure half when the two closure halves 102, 104 are in a closed state.

To allow the two closure halves 102, 104 to be identical, the first inter-fitting wall portion 206 extends no more than one-half the entire length of the periphery defined by the distal end portion 212 of peripheral sidewall 176. Similarly, the second and third inter-fitting wall portions 208, 210 that cooperate with the corresponding inter-fitting wall portion 206 of the other closure half extend more than half of the length of the periphery defined by the distal end portion 212 of peripheral sidewall 176.

With reference to FIG. 10, the engagement between the inter-fitting sidewall portions 206, 208, 210 is illustrated. As shown in this figure, the first inter-fitting wall portion 206 extends into receiving channel 214 formed between the second and third inter-fitting wall portions 208, 210 of the other closure half. This inter-fitting relationship provides additional structural rigidity to the overall closure 100 in the closed condition.

It shall be understood, that no portion of the length of the first inter-fitting wall portion 206 shall overlap substantially any portion of the length of the second and third inter-fitting wall portions 208, 210 for the same closure half. This lack of overlapping relationship at any portion of the periphery defined by the peripheral sidewall 176 prevents any interference between the same inter-fitting wall portion of both closure halves 102, 104. More particularly, this relationship prevents the first inter-fitting wall portion of both closure halves 102, 104 from interfering with one another in the closed state.

In the illustrated embodiment, the distal ends of the second and third inter-fitting wall portions 208, 210 could slightly overlap at the same location of the distal end portions of the first inter-fitting wall portion 206. However, they shall not substantially overlap. As used herein, substantially overlapping shall be such overlap that is so great that it substantially inhibits the closure of the closure halves 102, 104. Some very minimal overlap at the distal ends of the inter-fitting wall portions 206, 208, 210 shall be permitted because the closure halves 102, 104 are generally formed from plastic that has some resiliency that will flex allowing closure even if there is some slight overlap.

While illustrated as substantially continuous sidewall portions, the individual inter-fitting wall portions could be formed from partial segments.

As noted previously, the closure halves 102, 104 are preferably formed from molded plastic as a single continuous component. As such there are only two components needed for an entire closure according to this embodiment. The two components would include all of the latches, buckles, and hinge portions.

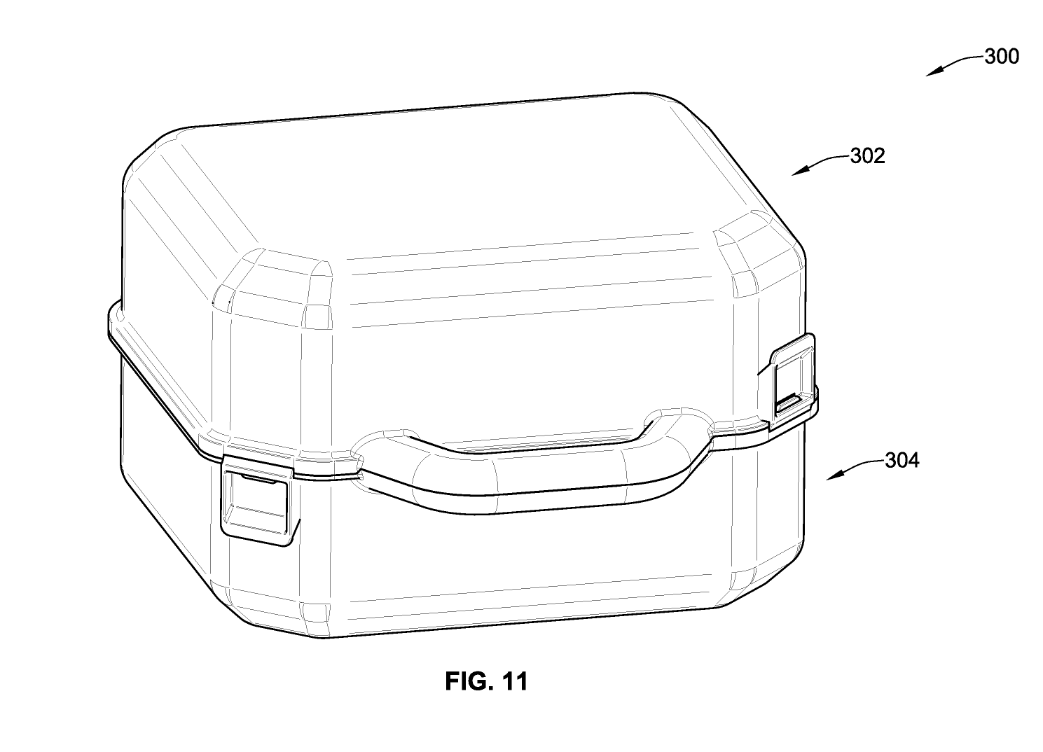

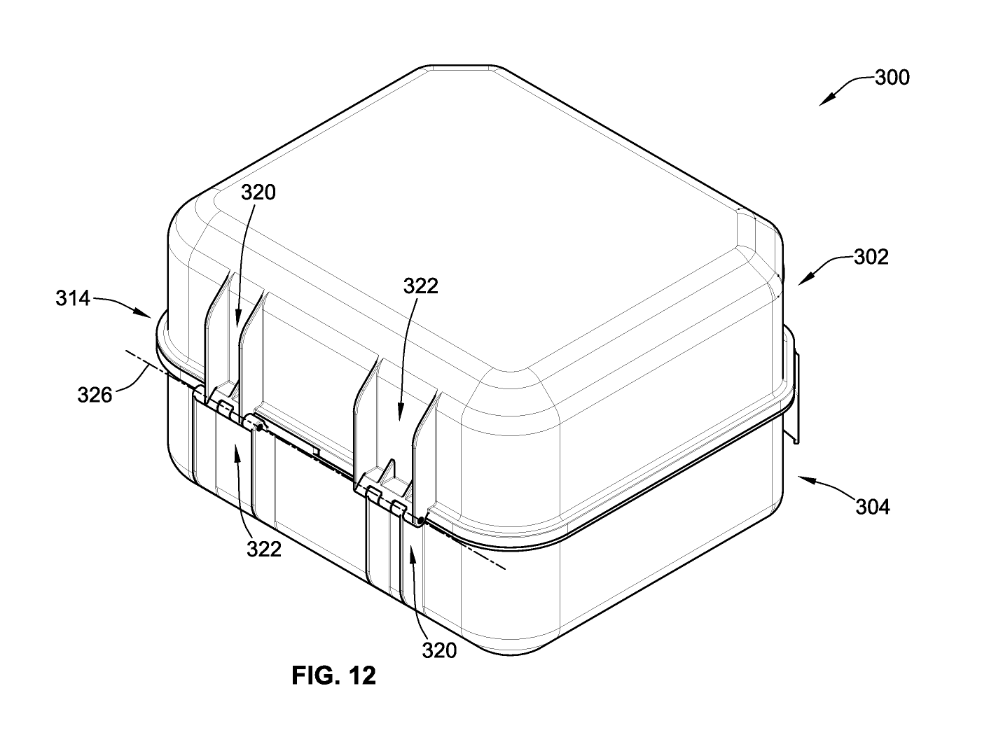

FIGS. 11 and 12 illustrate a further embodiment of a closure 300 according to the present invention. The closure 300 includes first and second closure halves 302, 304 that are hingedly coupled to one another for transitioning between open and closed states. The closure 300 is substantially similar to the prior embodiment and only the differences therebetween will be focused on with regard to this embodiment.

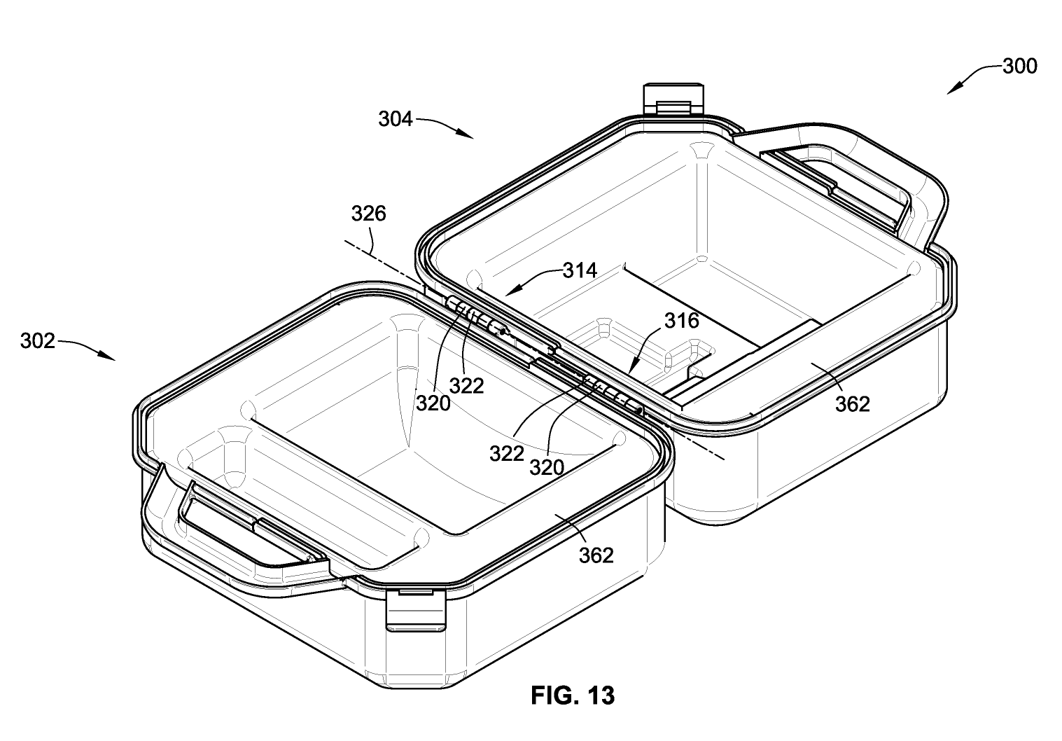

The closure 300 includes a pair of hinge arrangements 314, 316 that defined a hinge axis 326 about which the first and second closure halves 302, 304 rotate relative to one another between the closed state (FIG. 12) and the open state (FIG. 13).

The hinge arrangements 314, 316 both include a male hinge portion 320 and a female hinge portion 322. The male and female hinge portions 320, 322 of the different closure halves 302, 304 cooperate with one another to hingedly connect the first and second closure halves 302, 304 to one another.

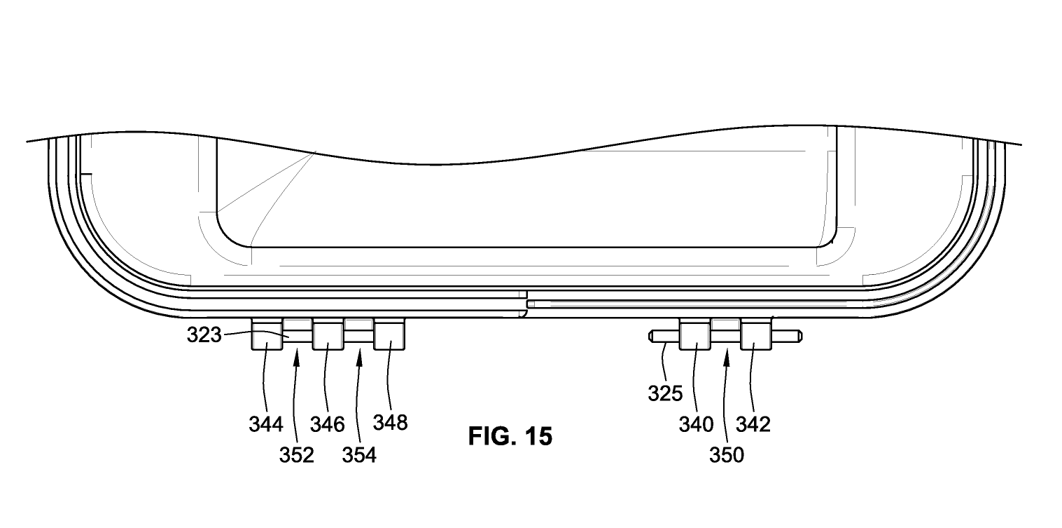

The hinge arrangements 314, 316 of the present embodiment include hinge pins 323, 325 (see FIG. 15) that couple the male and female hinge portions 320, 322 to one another. With reference to FIG. 12, the hinge pins 323, 325 are coaxial with one another along hinge axis 326.

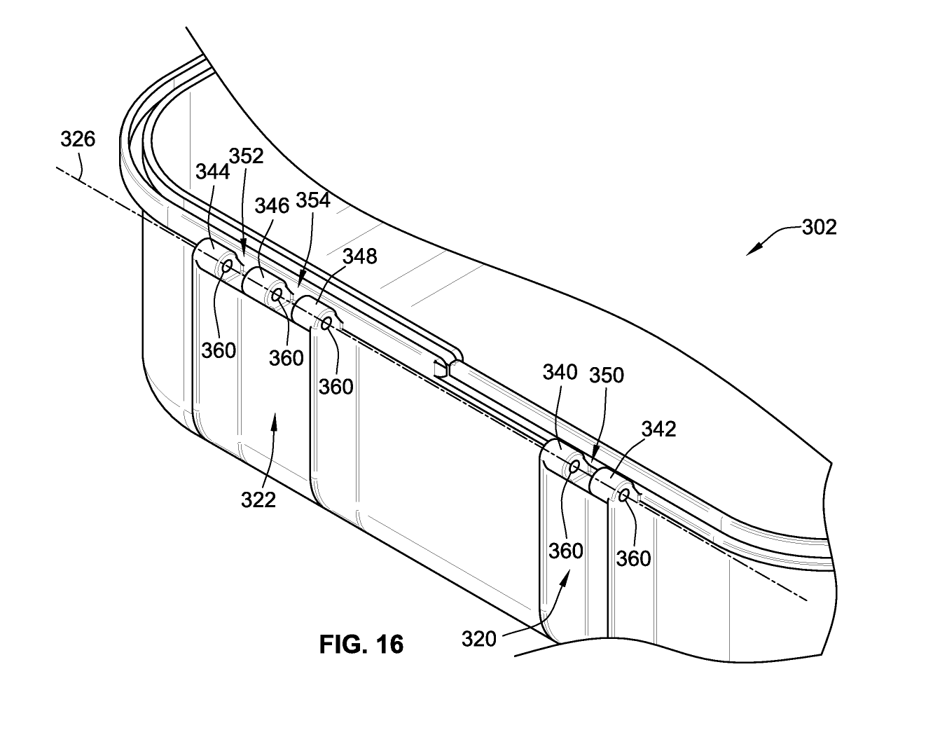

With reference to FIG. 16, a partial illustration of one of the closure halves 302 is illustrated. The male portion 320 includes first and second tabs 340, 342 and female hinge portion 322 includes tabs 344, 346, 348. In between tabs 340, 342 is a tab receiving channel 350. When assembled with another closure half, the middle tab of the female hinge portion 322, namely the tab 346 of the other closure half, is received in the tab receiving channel 350. Similarly, the female hinge portion 322 includes a pair of tab receiving channels 352, 354 that receive tabs 340, 342 of the cooperating closure half

The tabs 340, 342, 344, 346, 348 all include hinge pin apertures 360 that are coaxial with one another.

Further, with reference to FIG. 13, this embodiment illustrates a pair of thin film inserts 362 inserted into the internal cavities of the closure halves 302, 304. These inserts 362 can be formed to take the shape of the products that are to be carried in the closure 300. For instance, the inserts 362 could be shaped like an electric power tool, such as a drill or saw, to better secure a product within the closure 300.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A closure comprising:
a first closure half including a first male hinge portion and a first female hinge portion;
a second closure half including a second male hinge portion and a second female hinge portion, the second male hinge portion being configured to interfit with the first female hinge portion and cooperate to form a first hinge arrangement defining a first hinge axis, the second female hinge portion being configured to interfit with the first male hinge portion and cooperate to form a second hinge arrangement defining a second hinge axis;
wherein the first and second closure halves are identical; and
wherein the first and second hinge axis are co-axial and the first and second closure halves rotate relative to one another via the first and second hinge arrangements about the first and second hinge axes between open and closed states.

2. The closure of claim 1, wherein each of the first and second closure halves include a peripheral sidewall bounding an internal cavity; the peripheral sidewall having an open distal end, the open distal end defining a continuous periphery; the open distal end of the peripheral sidewall including a first interfitting wall portion extending no more than one half the length of the continuous periphery and a second interfitting wall portion extending no more than one half the length of the continuous periphery.

3. The closure of claim 2, wherein substantially no length of the first interfitting wall portion overlaps any substantial length of the second interfitting wall portion at any point along the length of continuous periphery.

4. The closure of claim 2, wherein the first interfitting wall portion of the first closure half is positioned radially outward from and overlaps with a length of the second interfitting wall portion of the second closure half when the first and second closure halves are in the closed state.

5. The closure of claim 3, wherein the first interfitting wall portion of the first interfitting wall portion is spaced laterally outward from the second interfitting wall portion.

6. The closure of claim 2, wherein the distal end of the peripheral sidewall includes a third interfitting wall portion extending no more than one half the length of the distal end of the peripheral sidewall, the third interfitting wall portion being spaced laterally outward from the second interfitting wall portion defining a receiving channel therebetween.

7. The closure of claim 6, wherein, when in the closed state, the first interfitting wall portion of the first closure half is positioned within the receiving channel of the second closure half and the first interfitting wall portion of the second closure half is positioned within the receiving channel of the first closure half

8. The closure of claim 1, further including first and second hinge pins, the first hinge pin passing through the first female hinge portion and second male hinge portion along the first hinge axes to couple the first female hinge portion to the second male hinge portion and the second hinge pin passing through the first male hinge portion and second female hinge portion along the second hinge axes to couple the first male hinge portion to the second female hinge portion.

9. The closure of claim 1, wherein the first male hinge portion includes a first tab including a hinge pin receiving channel and the second female hinge defines a first pair of spaced apart tabs defining hinge pin receiving channels, wherein the second male hinge portion defines a second tab including a hinge pin receiving channel and the second female hinge defines a second pair of spaced apart tabs defining hinge pin receiving channels, wherein the first tab is interposed between the tabs of the second pair of spaced apart tabs and the second tab is interposed between the tabs of the first pair of spaced apart tabs, wherein all hinge pin receiving channels are substantially co-axial.

10. The closure of claim 9, further comprising first and second hinge pins, the first hinge pin passing through the first tab and second pair of spaced apart tabs and the second hinge pin passing through the second tab and the first pair of spaced apart tabs.

11. The closure of claim 1, wherein the first closure half includes a first peripheral sidewall and the second closure half includes a second peripheral sidewall; and
wherein:
the first male hinge portion includes a first clip arrangement hingedly attached to the first peripheral sidewall;
the second male hinge portion includes a second clip arrangement hingedly attached to the second peripheral sidewall;
the first female hinge portion includes a catch channel matingly receiving the first clip arrangement therein; and
the second female hinge portion includes a catch channel matingly receiving the second clip arrangement therein.

12. The closure of claim 11, wherein the first clip arrangement includes a pair of first prongs separated by a first biasing channel, the pair of first prongs extending into the catch channel of the second female hinge portion, at least one of the pair of first prongs including a catch for engaging a cooperating catch structure of the second female hinge portion to secure the first clip arrangement within the catch channel.

13. The closure of claim 12, wherein the first clip arrangement further includes a locking member having a locked state wherein the locking member extends between the pair of first prongs preventing the pair of first prongs from resilient biasing towards one another such that the catch cannot disengage the cooperating catch structure.

14. The closure of claim 13, wherein the locking member includes an unlocked state wherein the locking member does not extend between the pair of first prongs such that the pair of first prongs can be resiliently biased towards one another such that the catch can disengage the cooperating catch structure.

15. A method of forming a closure comprising:
providing a pair of identical closure halves, each half having a male hinge portion and a female hinge portion;
coupling the pair of identical closure halves such that the male hinge portion of each closure half interfits with the female hinge portion of the other one of the closure halves.

16. The method of claim 15, further comprising inserting a hinge pin through each set of interfitted male and female hinge portions, the pair of closure halves being pivotable about the hinge pins, the hinge pins being aligned co-axial.

17. The method of claim 15, wherein each closure half includes a main body that defines a storage cavity, the male hinge portion is hingedly coupled to the main body, the male hinge portion includes a first catch portion and the female hinge portion includes a cooperating second catch portion, wherein coupling includes engaging the first and second catch portions such that the male and female hinge portions are fixed to one another.

18. The method of claim 17, further comprising locking the position of the first catch portion to prevent disengagement of the first catch portion from the second catch portion.

19. The method of claim 18, wherein the male hinge portion includes a catch prong that includes the first catch portion, wherein locking the position of the first catch portion includes abutting a prop against the catch prong to prevent biasing of the catch prong away from the second catch portion.

20. The method of claim 19, wherein the prop is formed as part of the male hinge portion.

21. The method of claim 19, wherein abutting a prop includes rotating the prop from a disengaged state that permits resilient biasing of the catch prong away from the second catch portion into a locked state that prevents resilient biasing of the catch prong away from the second catch portion.
